(19) United States
(12) Patent Application Publication
(10) Pub. No.: US 2002/0057940 A1
(43) Pub. Date: May 16, 2002

(54) Apparatus, in particular writing instrument

(76) Inventor: Rainer Kaufmann, Delmenhorst (DE)

Correspondence Address: SQUIRE, SANDERS & DEMPSEY L.L.P., 14th Floor, 801 South Figueroa, Los Angeles, CA, 90017-5554, US

(21) Appl. No.: 09/883,722

(22) Filed: Jun. 18, 2001

(30) Foreign Application Priority Data
Jun. 10, 1999 (DE) DE 41 15 685 C2
Jun. 9, 2000 (EP) PCT/EP00/05361
Jun. 10, 1999 (DE) 199 26 488.0-27

(51) Int. Cl. B43K 5/00

(52) U.S. Cl. 401/198; 401/196

(57) ABSTRACT

An apparatus, in particular writing instrument, for the application of liquid on a surface by means of an application element (12; 25), comprises:

a liquid chamber (16) to accommodate a liquid reservoir,

a capillary liquid duct (16; 25, 26) to supply said application element (12; 25) with liquid,

a capillary storage (18; 26) to temporarily accommodate liquid in case of an air pressure or temperature change, which capillary storage is in direct contact with the capillary liquid duct (16; 25, 26) outside the liquid chamber,

a ventilation way (22, 4; 22, 28, 25) passing at least partially through a capillary material (4; 25) and through which air can enter the liquid chamber in case of a reduction in the volume of liquid taken up in the liquid chamber,

wherein capillarities of said liquid duct are greater than those of said capillary material of said ventilation way and capillarities of said storage are smaller than those of said capillary material of said ventilation way, which apparatus is characterized in that

at least a part (4) of the wall (2, 4; 25) of the liquid chamber (6) includes the capillary material and forms a part of the ventilation way (22, 4; 22, 28) and the smallest capillarity of the capillary material of said ventilation way is greater than that of the larger part of the storage (18; 26) and smaller than the smallest capillarity of the liquid duct (16; 25, 26).

The invention relates to an apparatus, in particular a writing instrument, according to the preamble of claim 1.

With the known writing instrument (DE 41 15 685 C2) according to the preamble of claim 1, the capillary material of the ventilation way is formed by the greatest capillaries of the liquid duct. This causes some problems in practice:

Especially in case the liquid duct is a capillary wick, it is difficult to set the distribution of the capillaries or their equalness along the whole length during manufacturing of the wick, which means that the writing performance of different instruments is different. Furthermore, in case wicks with small diameters are used, the ink flow is limited in case of an even distribution of the capillaries, for all capillaries of the liquid duct, the capillaries of which are not distinctly different from the air inlet capillary, do not contribute to the ink flow.

It is an object of the invention to improve an apparatus according to the preamble in that it can be manufactured with low costs and allows a large liquid flow through the liquid duct also in case it is formed with a small diameter.

A solution on this object is achieved by the features of appended main claim. By forming the capillary air inlet according to the invention not by the greatest capillaries of the liquid duct, but by capillary material of the partition wall itself it is possible to set the performance of the air inlet almost fully independent from the performance of the capillary liquid duct, under the precondition the predetermined relations between the capillaries are fulfilled. In case the whole partition is formed from capillary material, its manufacturing is especially simple.

Appended subclaims are directed towards advantageous embodiments and improvements of the inventive apparatus.

Claim 2 characterizes an embodiment which can be especially simply manufactured, for the average capillaries of the respective materials can be set during a manufacturing process.

Claim 3 characterizes a simple basic design of the apparatus.

Claim 4 is directed towards an embodiment of the apparatus, wherein as known per se the liquid duct, which is preferably formed as a wick, passes through the partition into the liquid reservoir.

Embodiment of claim 5 is simplified with respect to its manufacturability, for it is not necessary to form the partition with the whole.

With features of claim 6, the advantage is achieved that the manufacturing and amounting of the functional members wick and storage are unitized, for both functional members are integrated to one member.

The apparatus according to the invention may be used according to claims 7 and 8 not only as a writing instrument or an instrument to apply other liquid materials, but can also be used as a supply means for a printing head, as e.g. it is used in an ink jet printer.

The invention will be explained in the following with reference to the appended drawings by example and with further details.

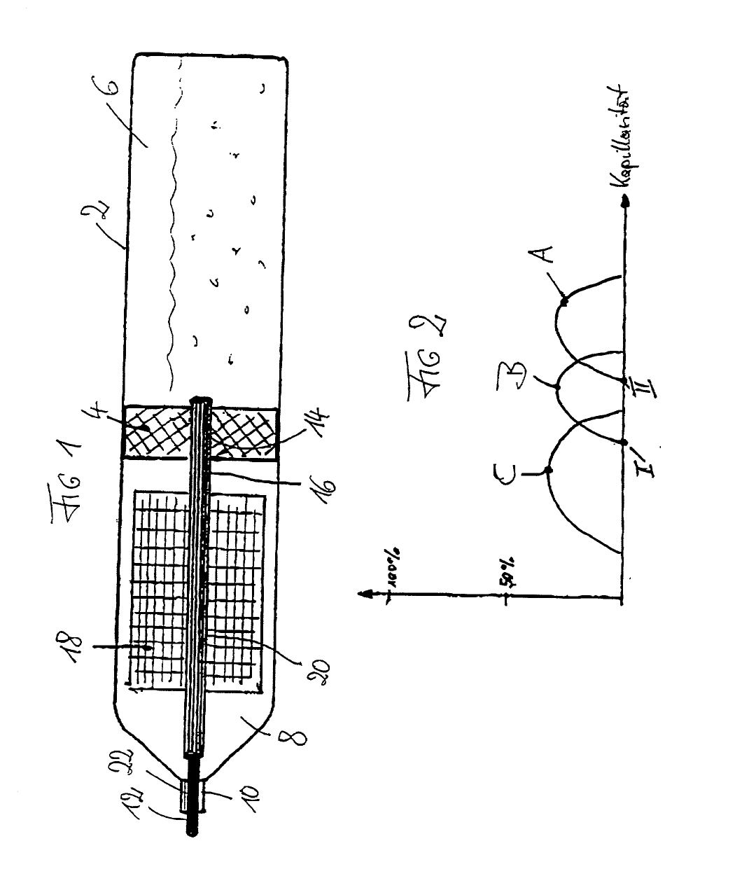

FIG. 1 is a cross section through an inventive instrument,

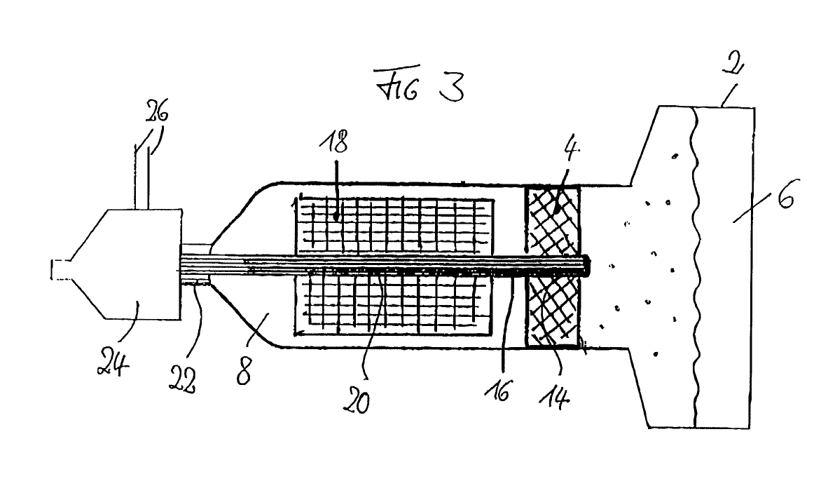

FIG. 2 shows graphs to explain the capillary features of different functional parts,

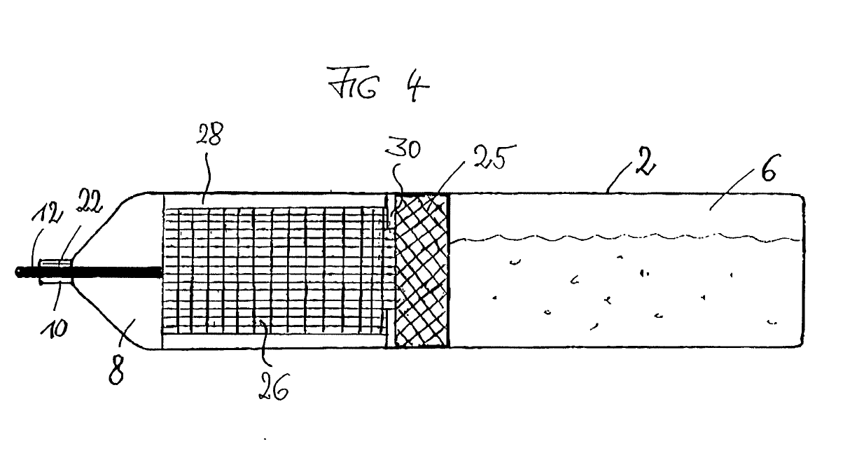

FIG. 3 is a view similar to FIG. 1 of a further embodiment of the apparatus and

FIG. 4 shows another embodiment of the apparatus.

According to FIG. 1, a writing instrument consists of a cylindrical case 2 whose interior is divided by a partition 4 into a liquid chamber 6 and a further chamber 8. At the left extremity, as in FIG. 1, the case 2 tapers into a cone and ends in a cylindrical projection 10. An application element 12 is attached to an opening in this projection 10. This element can be a nip, felt point, or brush.

The dividing partition 4 has a connecting opening 14, which is completely filled by a capillary liquid duct in the form of a wick 16, extending as far as the application element 12 and supplying it with liquid from the liquid chamber 6.

In the chamber 8 a capillary storage 18 is included, which for the sake of example is represented as a cylinder with a transit canal 20 through which the liquid duct 15 leads. The dimensions are such that the material of the liquid duct 16 is in direct contact, at least in some areas, with the material of the storage 18.

The capillary reservoir can be fixed mechanically within the chamber 8 by attachments not illustrated in the diagram.

In order to ventilate the liquid chamber 6 a ventilation canal 22 leads through the projection 10. The capillary storage 18 is so contrived that the air can pass it through the chamber 8 up to the dividing partition 4, which consists of capillary material.

FIG. 2 shows three curves, A, B and C, demonstrating the percentage distribution of the capillarities for the liquid duct 16 (curve A), the material of the dividing partition 4 (curve B), and the capillary storage (curve C). The capillarity increases from left to right of FIG. 2, that is to say that the elevation, or vertical rise, increases to the point where a liquid penetrates the appropriate capillary. This elevation is given by the dimensions, especially by the diameter of the capillaries, as well as by the adhesion between liquid and material. Point I shows the smallest capillarity of the capillary material of the dividing partition 4; point II shows the smallest capillarity of the material of the liquid duct 16. With similar materials the capillarity decreases with the increasing diameter of the capillaries.

It is necessary for the efficient functioning of the instrument that the smallest capillarity I of the dividing partition 4, which forms a part of the ventilation way, should be greater than the capillarity of the predominant part of the capillary storage 18 (curve C). Otherwise the storage would suck itself full with the liquid. It is furthermore important, that the smallest capillarity I should be smaller than the smallest capillarity of the liquid duct 16, otherwise the portion of the liquid duct with the smallest capillarity would serve to let in air.

It is advantageous if, as shown in the example illustrated, the mean capillarity of the fluid duct (by symmetrical distribution approximately the upper point of curve A), is greater than that of the dividing partition (upper point of curve B), which in turn is greater than the mean capillarity of the capillary storage 18 (curve C). As a result of the incomplete homogeneity of the various materials there arise variations in the capillarity of more or less severity.

The function of the writing instrument is as follows:

Let it be supposed that the writing instrument in FIG. 1 is held with the point downwards. As long as the instrument is not written dry, there will be liquid above the dividing partition 12. At first the smallest capillaries of the liquid duct 16 suck themselves full with liquid, according to their capillarity. This can only happen when, in the dividing partition 4, there are larger capillaries or capillaries with smaller capillarity, through which air can pass into the liquid chamber 6. If the liquid duct has only such capillaries whose capillarity is greater than those of the dividing partition 4, it will suck itself completely full of liquid. The reason that the liquid does not run out of the vertically held writing instrument is that a partial vacuum is formed in the liquid chamber 6, whose strength is determined by the capillarity of the capillaries in the dividing partition 4 and with proper coordination must be so that it can support the weight of the liquid column from the upper level of the liquid in the liquid chamber 6 right down to the lower end of the application element 12. The capillaries of the dividing partition 4 with greater capillarity are also, depending on the pressure conditions, filled with liquid.

When the material of the capillary storage 18 comes in contact with the liquid taken up by the liquid duct 16, only those capillaries of the capillary storage 18 suck themselves full with liquid which are in the position of being able to suck the largest capillary of the dividing partition empty (i.e., the area with the least capillarity), and to form a bubble at their contact point with the liquid in the liquid chamber 6.

Consequent to the conditions shown in FIG. 2, the capillary storage 18 remains to a large extent empty.

When the instrument is used for writing, liquid is transported through the liquid duct 16, as a result of adhesion between the application element 12 and the surface over which the application element 12 is drawn. Air accordingly flows in through the largest capillary of the dividing partition:

E.g., if the writing instrument becomes warm, or the atmospheric pressure sinks, the partial vacuum in the liquid chamber 6 also sinks, whereby the capillaries in the capillary storage 18 can suck themselves full of as much liquid as they are capable of taking up against the decrease in the partial vacuum. The partial vacuum in the liquid chamber 6 increases, so that the process comes to a standstill, without liquid escaping from the application element 12. If the temperature decreases or the atmospheric pressure increases again, the procedure is reversed; the increase in the partial vacuum in the liquid chamber 6 sucks the capillary liquid storage empty.

The instrument described can be adapted in a variety of ways. For example it is not necessary for the dividing partition 4 to consist entirely of capillary material. It can have a ring-shaped area made from capillary material. The capillaries in the dividing partition 4 as well as in the capillary liquid storage do not necessarily have to be so formed that their entire material is porous or capillary; they can also be formed by defined slits, which in the case of the dividing partition 4 reach through the dividing partition from the chamber 8 to the chamber 6, or in the case of a capillary storage 18 are in direct contact with the capillaries of the liquid duct 16. It is also unnecessary for the ventilation way to reach through the chamber 8 and the dividing partition 4. It can also be formed from capillary material in another part of the wall area of the chamber 6. The fully filled aperture 14 of the liquid duct 16 does not necessarily have to be formed in the dividing partition 4.

All in all, this invention achieves ease of fabrication for the writing instrument in a well-definable standard of quality. The material of the liquid duct 16 permits convenience of writing due to full absorption through a sufficiently high level of capillarity as well as sufficiently small transmitting resistance, independent of the material in the dividing partition 4, which determines the writing speed and can be chosen independently of the material of the capillary reservoir. Thanks to this, leakproof security can be guaranteed, even with variations of pressure. In extreme cases the materials can be selected in such a way that sharply differentiated distribution functions are available, whereby the three curves A, B, and C no longer overlap. Functional security is also guaranteed in the case of handy writing instruments of small diameter.

FIG. 3 shows an implementation of the instrument with a liquid chamber 6 of a very large volume and an application element 24 as might be used, for example, in the printing head of a laser jet printer, equipped with jet nozzles and controlled by electrical connections 26. The liquid duct 16 leads directly to the application element 24. Otherwise the function of the instrument in FIG. 3 corresponds to that in FIG. 1. The same reference signs refer to parts having similar functions.

FIG. 4 shows the further embodiment of a writing instrument, wherein elements corresponding to elements of the embodiments described above are designated by the same reference numerals.

The essential difference between the embodiment of FIG. 4 and the embodiments mentioned above is that partition 25 is formed without a through hole and that liquid duct and capillary storage are combined to an integral member 26, which contacts with its rear face direct the capillary material of partition 25 and is connected with the application element 12 via its front face. Member 26, which is formed by capillary material, is fitted into case 2 such that it is in safe direct contact with partition 25, wherein along the outer circumference of member 26 at least one air channel 28 remains free, which may be extended in a part 30, which extends parallel to the surface of the partition 25.

Capillaries of the material of partition 25 and member 26 are set with respect to the functions of said parts according to those of FIG. 2, i.e. partition 25 includes capillaries which correspond to the liquid duct (graph A) as well as capillaries which correspond to the air inlet (graph B). This is necessary, for the liquid in the present embodiment must pass directly through partition 25 into member 26, which has the function of the liquid duct as well as the function of the temporary storage. Accordingly, member 26 includes capillaries according to graph C (storage) as well as according to graph A (liquid duct). It has to be understood that graph C may overlap with graph A.

It is important that in a region where member 26 is in direct contact with partition 25, there are present capillaries which correspond to graph A, i.e. capillaries with the great capillarity which form the liquid duct. By this means, capillaries with a great capillarity of member 26 suck in liquid through the capillaries with the great capillarity of partition 25 and get full of liquid to form the liquid duct which connects application element 12 with liquid reservoir. Section 30 of air channel 28 is adjacent portions of partition 25, with their smallest capillarity is within the range of graph B, i.e. which form air inlet capillaries. Further, it is essential that the material of member 26 includes a distribution of capillaries, which covers graphs C and B (FIG. 2) or corresponds to their combination and that the material of partition 25 as a distribution of capillarities, which corresponds to a cover of graphs A and B or their combination.

It has to be understood that also with the embodiments according to FIGS. 1 and 3 there can be used a liquid duct and a capillarity storage as an integrated member instead of both members being independently manufactured, wherein the integrated member combines both functions. Partition 25 of the embodiment according to FIG. 4 could also be used in an instrument according to FIGS. 1 and 3, wherein the liquid duct than is in direct contact with the partition.

1. Apparatus, in particular writing instrument, for the application of liquid on a surface by means of an application element (12;25), comprising:
a liquid chamber (16) to accommodate a liquid reservoir,
a capillary liquid duct (16;25, 26) to supply said application element (12;25) with liquid,
a capillary storage (18;26) to temporarily accommodate liquid in case of an air pressure or temperature change, which capillary storage is in direct contact with the capillary liquid duct (16;25, 26) outside the liquid chamber,
a ventilation way (22, 4;22, 28, 25) passing at least partially through a capillary material (4;25) and through which air can enter the liquid chamber in case of a reduction in the volume of liquid taken up in the liquid chamber,
wherein capillarities of said liquid duct are greater than those of said capillary material of said ventilation way and capillarities of said storage are smaller than those of said capillary material of said ventilation way,
characterized in that
at least a part (4) of the wall (2, 4;25) of the liquid chamber (6) includes the capillary material and forms a part of the ventilation way (22, 4;22, 28) and the smallest capillarity of the capillary material of said ventilation way is greater than that of the larger part of the storage (18;26) and smaller than the smallest capillarity of the liquid duct (16;25, 26).

2. Apparatus in accordance with claim 1, characterized in that the mean capillarity of the liquid duct (16;25, 26) is larger, and the mean capillarity of the capillary storage (18;26) is smaller than the mean capillarity of the capillary material (4;25) of the parts of the wall of the liquid chamber (6) belonging to the ventilation way (22, 4;22, 28, 25).

3. Apparatus in accordance with claim 1 or 2, characterized in that a case (2) of the apparatus is divided into two chambers (6, 8) by a dividing partition (4;25) consisting partly at least of the capillary material belonging to the ventilation way, wherein one of these chambers forms the liquid chamber; the other takes up the capillary storage (18, 28) and is traversed by the capillary liquid duct (16;26).

4. Apparatus according to claim 1, characterized in that the partition (4) has an opening (14) traversed by said capillary liquid duct (6) being in direct contact with the edge of said opening.

5. Apparatus according to claim 3, characterized in that said liquid duct (28) is in direct contact with a portion of said partition (25) consisting of capillary material, wherein the capillarity of such portion is set according to that of said liquid duct.

6. Apparatus according to any of claims 1 to 5, characterized in that said liquid duct and said capillary storage are formed as an integral member (26).

7. Apparatus according to any of claims 1 to 6, characterized in that said liquid duct (12) is formed by a writing nib, painting nib or a brush.

8. Apparatus according to any of claims 1 to 6, characterized in that the application element is a printing head (24) of a printer.
